(19) United States
(12) Patent Application Publication
(10) Pub. No.: US 2015/0201092 A1
(43) Pub. Date: Jul. 16, 2015

(54) IMAGE PROCESSING APPARATUS, METHOD OF SETTING INFORMATION OF IMAGE PROCESSING APPARATUS, AND RECORDING MEDIUM

(71) Applicant: Kohichi SADANO, Kanagawa (JP)

(72) Inventor: Kohichi SADANO, Kanagawa (JP)

(73) Assignee: RICOH COMPANY, LTD., Tokyo (JP)

(21) Appl. No.: 14/592,773

(22) Filed: Jan. 8, 2015

(30) Foreign Application Priority Data
Jan. 16, 2014 (JP) 2014-005641
Dec. 16, 2014 (JP) 2014-254141

(51) Int. Cl. H04N 1/00

(52) U.S. Cl. CPC H04N 1/00114; H04N 1/00411; H04N 1/00413; H04N 2201/0079; H04N 2201/0094

(57) ABSTRACT

An image processing apparatus displays on a display a first interactive screen that guides a user to configure automatic sender designation information when setting information stored in a memory indicates that the automatic sender designation information is not configured, and updates the setting information to indicate that the automatic sender designation information is configured in response to configuration of the automatic sender designation information by a user through the first interactive screen so as to prevent display of the first interactive screen when the image processing apparatus is tuned on for the next time.

### CROSS-REFERENCE TO RELATED APPLICATIONS

This patent application is based on and claims priority pursuant to 35 U.S.C. §119(a) to Japanese Patent Application Nos. 2014-005641, filed on Jan. 16, 2004, and 2014-254141, filed on Dec. 16, 2014, in the Japan Patent Office, the entire disclosure of which is hereby incorporated by reference herein.

### BACKGROUND

1. Technical Field

The present invention generally relates to an apparatus, method, and program stored on a non-transitory recording medium, each of which sets information to be used for data transmission by an image processing apparatus.

2. Description of the Related Art

The recent image processing apparatuses, such as network scanners or printers, are provided with a function of transmitting image data that is obtained through scanning to a destination email address (referred to as the “scanned data email transmission”). In order to send the image data via email, a sender of the image data is previously set beforehand usually by an administrator of the image processing apparatus. If the sender is not previously set, a user may be forced to quite operation of transmitting to set the sender even in the middle of processing scanned data email transmission. Further, some users may not be familiar with operation of setting the sender, as such information is usually set by the administrator.

### SUMMARY

Example embodiments of the present invention include an image processing apparatus, which transmits data through a network. The image processing apparatus includes: a memory that stores setting information indicating whether automatic sender designation information is configured, the automatic sender designation information indicating whether to automatically designate a sender of data to be transmitted; and a processor to be executed in response to turning on of the image processing apparatus. The processor determines whether the automatic sender designation information is configured based on the setting information, displays on a display a first interactive screen that guides a user to configure the automatic sender designation information when the setting information indicates that the automatic sender designation information is not configured, and updates the setting information in the memory to indicate that the automatic sender designation information is configured in response to configuration of the automatic sender designation information by the user through the first interactive screen so as to prevent display of the first interactive screen when the image processing apparatus is tuned on for the next time. When an instruction for transmitting data is received, the processor further determines whether to automatically designate a sender of data to be transmitted based on the automatic sender designation information that is configured.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic block diagram illustrating a network configuration of an image processing system, according to an example embodiment of the present invention;

FIG. 2 is a schematic block diagram illustrating a structure of a multifunctional peripheral (MFP) of FIG. 1, according to an example embodiment of the present invention;

FIG. 3 is a schematic block diagram illustrating a hardware structure of a controller of the MFP of FIG. 2, according to an example embodiment of the present invention;

FIG. 4 is a schematic block diagram illustrating a functional configuration of the MFP of FIG. 2 that relates to setting of sender information, according to an example embodiment of the present invention;

FIG. 5A is a flowchart illustrating execution processing, performed by the image processing apparatus of FIG. 2, according to an example embodiment of the present invention;

FIG. 5B is a flowchart illustrating operation of processing an instruction for executing scanned data email transmission, performed by the image processing apparatus of FIG. 2, according to an example embodiment of the present invention;

FIG. 6 is a flowchart illustrating operation of processing initial setting using an initial execution wizard, performed by the image processing apparatus of FIG. 2, according to an example embodiment of the present invention;

FIG. 7 is a flowchart illustrating operation of designating a sender in scanned data email transmission, performed by the image processing apparatus of FIG. 2, according to an example embodiment of the present invention;

FIG. 8 is a flowchart illustrating operation of processing initial setting using an initial execution wizard, performed by the image processing apparatus of FIG. 2, according to an example embodiment of the present invention;

FIGS. 9A to 9D are example screens to be displayed at the image processing apparatus of FIG. 2, to request a user to set automatic sender designation;

FIGS. 10A to 10C are example screens to be displayed at the image processing apparatus of FIG. 2, in processing scanned data email transmission;

FIG. 11 is a flowchart illustrating operation of designating a sender in scanned data email transmission, performed by the image processing apparatus of FIG. 2, according to an example embodiment of the present invention; and

FIG. 12 is an example screen to be displayed at a client remotely located from the image processing apparatus of FIG. 2, in processing scanned data email transmission.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Referring now to the drawings, an apparatus capable of transmitting image data according to setting information and a method of configuring setting information to be used by that apparatus are explained according to an example embodiment of the present invention. In the following, an image processing apparatus capable of transmitting scanned image data via email, and a method of configuring setting information to be used by the image processing apparatus in scanned data email transmission are described as an example.

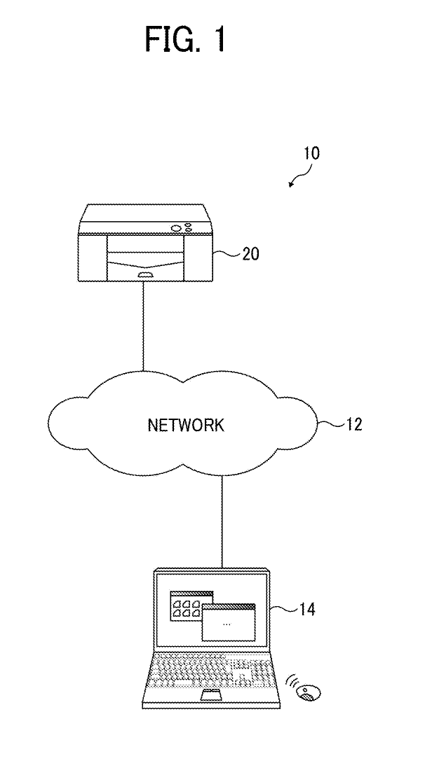

FIG. 1 illustrates a network configuration of an image processing system 10, which includes an information processing apparatus 14 and an image processing apparatus 20 connected through a network 12.

The information processing apparatus 14 may be implemented by any desired terminal operable by a user, such as a personal computer, smart phone, and tablet computer. For simplicity, the information processing apparatus 14 is referred to as the client 14. The client 14 is installed with software program that allows the client 14 to use at least one function provided by the image processing apparatus 20, such as a printer driver, scanner driver, print application, or scanner application.

The image processing apparatus 20 is any image processing apparatus having at least one of image processing functions, such as print function, scan function, and copy function, with communication function. In this example, it is assumed that the image processing apparatus 20 is implemented as the multifunctional peripheral (MFP) 20 capable of performing printing, scanning, and copying, and communicating via a network. For example, the MFP 20 performs image processing in response to an instruction received from a user through an operation panel of the MFP 20 or the client 14.

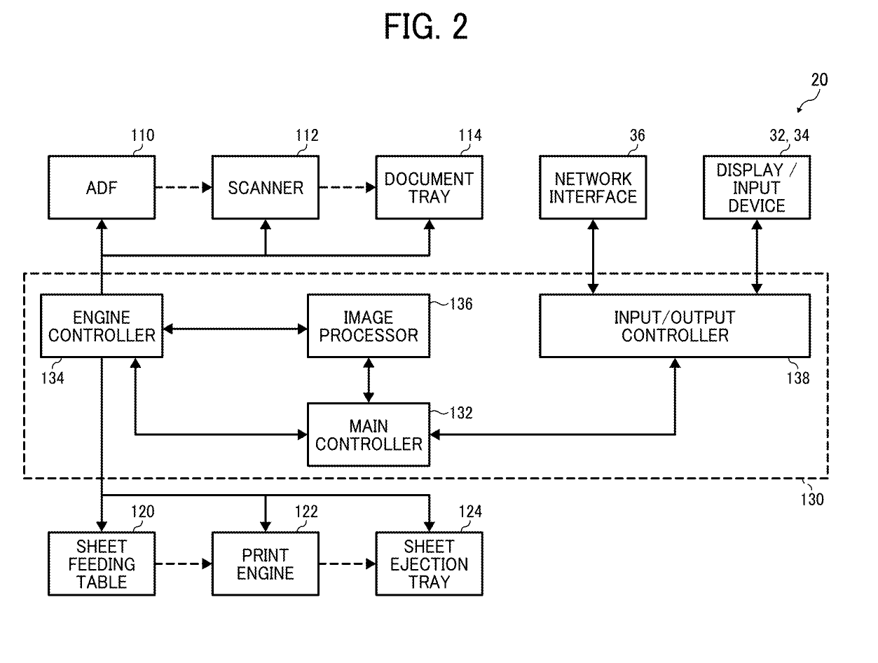

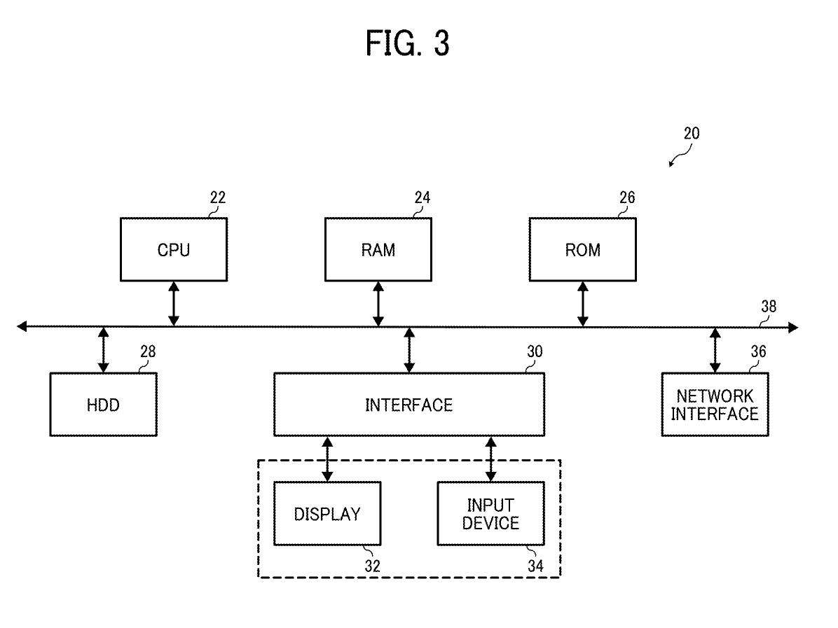

FIG. 2 is a schematic block diagram illustrating a structure of the MFP 20 including a controller 130. FIG. 3 is a schematic block diagram illustrating a hardware structure of the controller 130 of FIG. 2.

The MFP 20 includes an automatic document feeder (ADF) 110, a scanner 112, a document tray 114, a sheet feeding table 120, a print engine 122, a sheet ejection tray 124, and the controller 130. In this example, the MFP 20 including the scanner 112 and the print engine 122 is capable of performing scanning, printing, and copying.

The controller 130 includes a main controller 132, an engine controller 134, an image processor 136, and an input/output (I/O) controller 138. In FIG. 2, electrical connection is shown by the solid line, and a flow of document or recording sheet is shown by the dashed line.

As illustrated in FIGS. 2 and 3, the MFP 20 further includes a display 32, an input device 34, and a network I/F 36. The display 32 is an output interface, which visually displays various information such as an operation state of the MFP 20. The display 32 may be implemented by a liquid crystal display (LCD) having a touch panel. The input device 34 is an input interface, which allows a user to input various data directly to the MFP 20. More specifically, the input device 34 includes various keys such as the “START” key, a ten key, etc., as well as various keys or icons that are displayed through the display 32 such as a touch panel screen. For simplicity, the display 32 and the input device 34 may be collectively referred to as the operation panel.

The network I/F 36 is a communication interface circuit, which allows the MFP 20 to communicate with the other apparatus such as the client 14 via the network 12. The network I/F 36 may be implemented by an interface in compliance with the Ethernet or universal serial bus (USB).

In this example, the controller 130 may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

For example, as illustrated in FIG. 3, the controller 130 includes a central processing unit (CPU) 22, a random access memory (RAM) 24, a read only memory (ROM) 26, a hard disk drive (HDD) 28, and an interface 30, which are connected via a bus 38. The interface 30, which may be implemented by an interface circuit, is further connected with the display 32 and the input device 34 that together function as the operation panel. Further, in this example, the interface 30 may be connected to any desired removable recording medium such as a USB memory or an optical disc.

In one example, control program such as firmware may be stored in any desired nonvolatile memory such as the ROM 26, HDD 28, or a nonvolatile recording medium such as optical disc. When the control program stored in the nonvolatile memory is loaded onto a volatile memory such as the RAM 24, the CPU 22 controls hardware of the MFP 20 such as an integrated circuit of the MFP 20 according to the control program to operate as the controller 130 of FIG. 2.

Referring to FIG. 2, the main controller 132 controls entire operation to be performed by the MFP 20 through the controller 130, for example, by instructing each unit in the controller 130 to operate hardware of the MFP 20 to perform specific operation. For example, the engine controller 134 controls various devices related to scanning such as the scanner 112, or various devices related to printing such as the print engine 122, under control of the main controller 132. The image processor 136 applies image processing under control of the main controller 132. In one example, the I/O controller 138 inputs various signals or instructions received through the network I/F 36 to the main controller 132, or outputs various signals or instructions from the main controller 132, to communicate with the external apparatus such as the client 14 via the network I/F 36 through the network 12. In another example, the I/O controller 138 displays various information through the display 32 under control of the main controller 132, or sends various information input through the input device 34 to the main controller 132.

For example, in printing operation, the I/O controller 138 receives an instruction for printing with image data to be printed from the client 14 through the network interface 36, and transfers such instruction to the main controller 132. The image processor 136 generates drawing data based on the image data to be printed under control of the main controller 132. The drawing data is information, which is used by the print engine 122 to form an image on a recording sheet that is transferred from the sheet feeding table 120, and outputs the sheet with the printed image on the sheet ejection tray 124. The print engine 122 may form an image using any desired image forming method such as ink-jet printing method or electrophotograhic printing method.

In scanning operation, in response to an instruction for scanning received from the input device 34 operated by the user or the client 14 through the network I/F 36, the I/O controller 138 sends an image scanning execution signal to the main controller 132. In response to the image scanning execution signal, the main controller 132 instructs the engine controller 134 to drive the ADF 110 to transfer a document that is placed on the ADF 110 to the scanner 112. The engine controller 134 drives the scanner 112 to scan the document transferred from the ADF 110. In case a document to be scanned is not placed on the ADF 110, but placed on an exposure glass above the scanner 112, the scanner 112 scans the document through scanning its document surface.

The scanner 112 may scan the document using any desired scanning method such as charged coupled device (CCD) or contact image sensor (CIS) method. For example, the scanner 112, provided with an imaging element, optically scans the document surface to output the scanned data. The engine controller 134 outputs the scanned data generated by the scanner 112 to the image processor 136. The image processor 136 processes the scanned data obtained by the scanner 112 to generate image data under control of the main controller 132.

The image data generated at the image processor 136 may be stored in the HDD 28 according to a user instruction. Alternatively, the image data may be transmitted to a network folder of the client 14 or a file server on the network 12, through the I/O controller 138 and the network I/F 36. In case the image data is to be transmitted via email, the image data, which is addressed to a specific email address, is transmitted to an email server on the network 12 through the I/O controller 138 and the network I/F 36. The image data may be converted in any desired format such as portable document format (PDF), tagged image file format (TIFF), joint photographic experts group (JPEG), or XML paper specification (XPS), according to user preference or by default.

As described above, in this example, the MFP 20 is provided with the function of scanning a document to generate image data, and transmitting the image data via email to a specific destination. For simplicity, this function is referred to as the scanned data email transmission function. In performing this scanned data email transmission function, a sender of the image data (that is, the scanned data in this example) needs to be set. Assuming that the user at the MFP 20 needs to set a sender in prior to instructing the MFP 20 to transmit scanned data, it has been cumbersome for the user to input sender information through the operation panel of the MFP 20. Especially if the user is not familiar with setting operation using the operation panel of the MFP 20, such user feels uncomfortable with using the scanned data email transmission function.

The user usually registers sender information, such as in the form of address book, using an administrator setting menu of the MFP 20. When transmitting image data via email, the user may call the address book to select the registered sender information to designate the sender of image data. In the background art, in case the sender information is not previously registered, the user is not able to call the address book or select the sender information from the address book. In such case, since the user is not able to enter the sender information through a screen for instructing the scanned data email transmission function, the user needs to stop the scanned data email transmission operation, and call the administrator setting menu to set the sender information. Not only such operation has been cumbersome, some users may not know that the administrator setting menu needs to be called to enter the sender information.

In view of the above, the MFP 20 in this example is additionally provided with a function of automatically designating a sender of image data in performing scanned data email transmission. Further, the MFP 20 allows the user to easily set information regarding this automatic sender designation function using a wizard. This wizard is programmed to be executed, at least at the time when the MFP 20 is firstly executed after the MFP 20 is shipped to a user site, or at the time when the MFP 20 is firstly executed after the MFP 20 is returned to such state. Further, when the MFP 20 detects that the sender information is not set before transmitting image data via email, the MFP 20 automatically switches the screen for instructing the scanned data email transmission, to the screen for entering sender information, to guide the user to enter the sender information.

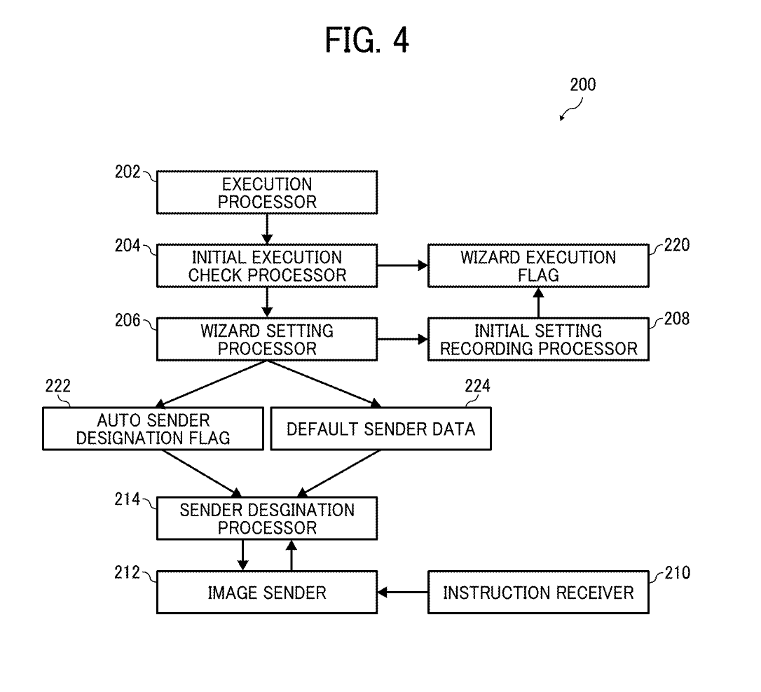

Referring now to FIGS. 4 to 7, and 9 to 10, operation of sending image data via email and setting a sender of image data is explained according to an example embodiment of the present invention.

FIG. 4 is a schematic block diagram illustrating a functional structure related to operation of setting a sender of image data. For example, the CPU 22 (FIG. 3) operates according to a control program loaded onto the RAM 24 to cause the main controller 132 to have the functional structure 200 of FIG. 4.

The functional structure 200 of the MFP 20 in FIG. 4 includes an execution processor 202, an initial execution check processor 204, a wizard setting processor 206, an initial setting recording processor 208, an instruction receiver 210, an image sender 212, and a sender designation processor 214.

In response to turning on of power of the MFP 20, the execution processor 202 calls the control program such as firmware from the ROM 26 or the HDD 28 onto the RAM 24 to cause the CPU 22 to perform operation of executing the MFP 20. As a part of execution processing, the execution processor 202 calls the initial execution check processor 204 to determine whether an initial execution wizard needs to be executed.

In this example, a wizard execution flag 220 is stored in the internal memory of the MFP 20 such as in the ROM 26 as one example of setting information. The wizard execution flag 220 is a flag having a value that indicates whether information to be set through the initial execution wizard has been set. The initial execution check processor 204 refers to the wizard execution flag 220 to determine whether information has been set using the initial execution wizard. In this example, the information to be set using the initial execution wizard includes setting information to be used by the MFP 20 in scanned data email transmission. More specifically, in this example, the wizard execution flag 220 having the “invalid” value means that information regarding the automatic sender designation function is not set. In such case, the initial execution check processor 204 calls the wizard setting processor 206.

The wizard setting processor 206, when called by the initial execution check processor 204, causes the display 32 to display an initial execution wizard screen to start interactive setting processing. In this example, the initial execution wizard is software program, which interacts with a user to set at least the items related to automatic sender designation for scanned data email transmission. While the initial execution wizard may also set other items such as network configuration and administrator information, for simplicity, the following describes the case where the setting item relating to sender information is set using the initial execution wizard. More specifically, in the following example, necessary items to be used for scanned data email transmission function other than the sender information, such as network configuration or email server configuration (such as the SMTP server name or address, or port number) are previously set using the initial execution wizard or an initial setting screen. The initial setting screen, which differs than a screen generated by the initial execution wizard, may be called according to a user instruction as a screen that allows a user input regarding various settings of the MFP 20.

The MFP 20 further stores an automatic (auto) sender designation flag 222 and default sender data 224, in the internal memory of the MFP 20 such as in the ROM 23. The auto sender designation flag 222, which is one example of automatic sender designation information, indicates whether the automatic sender designation function is to be used (“valid”) or not used (“invalid”). The default sender data 224, which is one example of sender information, indicates a registered sender to be automatically set in scanned data email transmission, when the auto sender designation flag 222 has the valid value. The initial execution wizard interacts with the user to set whether to allow the MFP 20 to automatically set a sender of image data in scanned data email transmission. When the sender is to be automatically set, that is, when the auto sender designation flag is set to valid, the initial execution wizard further interacts with the user to set sender information of the sender to be automatically set by default (“the default sender”). The default sender may be set based on a default value that is previously defined by a vendor, such as an administrator of the MFP 20. Alternatively, the default sender may be set based on information that is entered by the user through a screen that is generated by the initial execution wizard.

When settings through the initial execution wizard completes, the initial setting recording processor 208 is called. In response to completion of setting operation using the initial execution wizard, the initial setting recording processor 208 changes the value of the wizard execution flag 220 from “invalid” to “valid” to indicate that setting using the initial execution wizard is completed. With the value of the wizard execution flag 220 indicating that setting is done, calling of the initial execution wizard is not necessary. In this example, the value of the wizard execution flag 220 is stored in a nonvolatile memory, such as a flash ROM implemented by the ROM 23, to keep data even after the power of the MFP 20 is turned off. More specifically, the wizard execution flag 220 is kept stored, unless the MFP 20 is reset to its initial state, such as the state when the MFP 20 is shipped from a vendor.

When execution processing by the initial execution wizard completes, the MFP 20 may receive an instruction for executing scanned data email transmission. When the instruction receiver 210 receives an instruction for executing scanned data email transmission, from the operation panel operated by the user or from the client 14 through the network 12, the instruction receiver 210 calls the image sender 212.

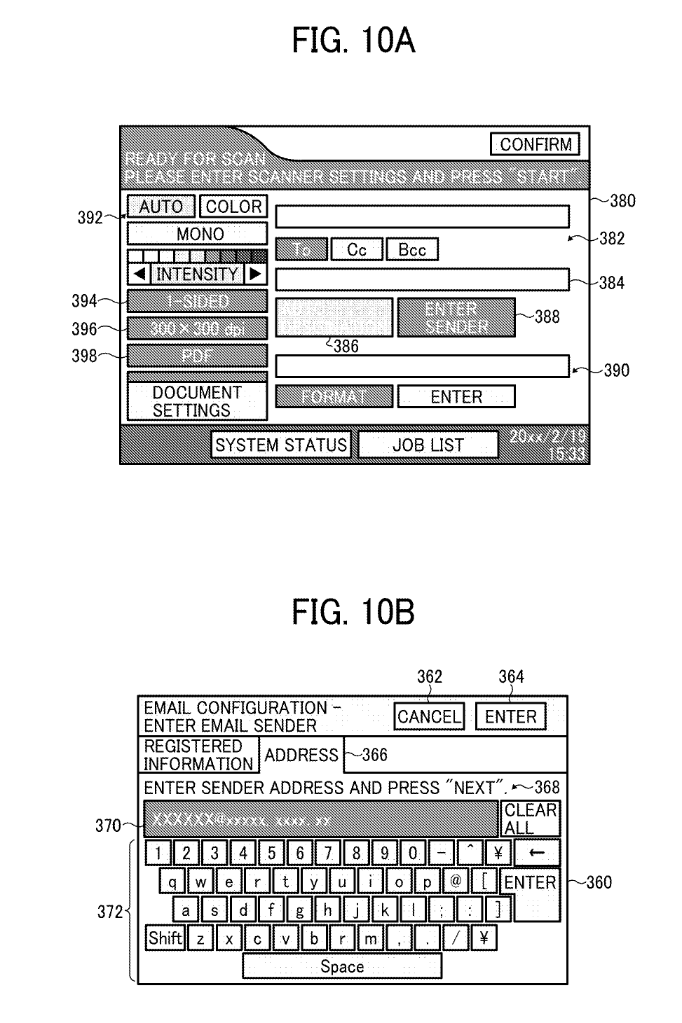

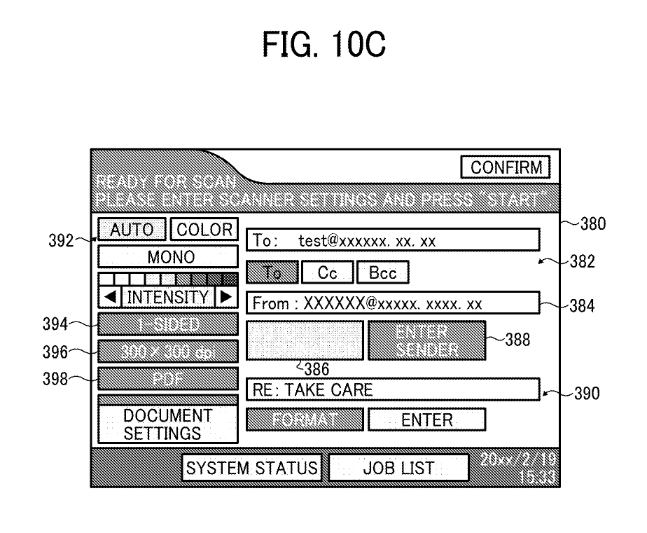

For example, the MFP 20 may display a menu through the display 32, which allows the user to select a function to be performed from a plurality of available functions. The user selects the scanned data email transmission function from the menu displayed through the display 32 to display a screen for scanned data email transmission as illustrated in FIG. 10A. Further, the user may place a document to be scanned on the ADF 110 or the exposure glass of the MFP 20. Through the screen for scanned data email transmission that is displayed by the operation panel, the user sets various setting information such as a file format of the image data to be transmitted, resolution of the image data to be transmitted, and a destination address to which the image data is transmitted. In response to selection of the “START” key on the operation panel, the instruction receiver 210 accepts the instruction for executing the scanned data email transmission, with the selected or entered setting information.

In response to the instruction for executing the scanned data email transmission, the image sender 212 instructs the engine controller 134 to scan the document to be scanned and the image processor 136 to generate image data in the specified format based on the scanned data. The image sender 212 instructs the I/O controller 138 to send the image data, as an attachment of email data addressed to the specified destination address, through the network I/F 36 in compliance with a simple mail transfer protocol (SMTP).

In prior to transmitting the image data via email, the image sender 212 calls the sender designation processor 214 to designate a sender of the image data to be transmitted. The sender designation processor 214 refers to the auto sender designation flag 222 stored in the memory of the MFP 20 to automatically set a sender of the image data based on the flag value. When the auto sender designation flag 222 is set to “valid”, the sender designation processor 214 automatically designates the default sender as indicated by the default sender data 224, as a sender of the image data. In such case, the screen for scanned data email transmission of FIG. 10A may have the default sender displayed in a text box 384.

When the auto sender designation flag 222 is set to “invalid”, and when there is no sender designation input through the screen for scanned data email transmission, the text box 384 remains blank. In such case, the sender designation processor 214 calls a sender input screen that interacts with the user to enter sender information such as a screen of FIG. 10B, and designates the sender that is entered by the user through the called sender input screen as a sender of the image data as illustrated in FIG. 10C.

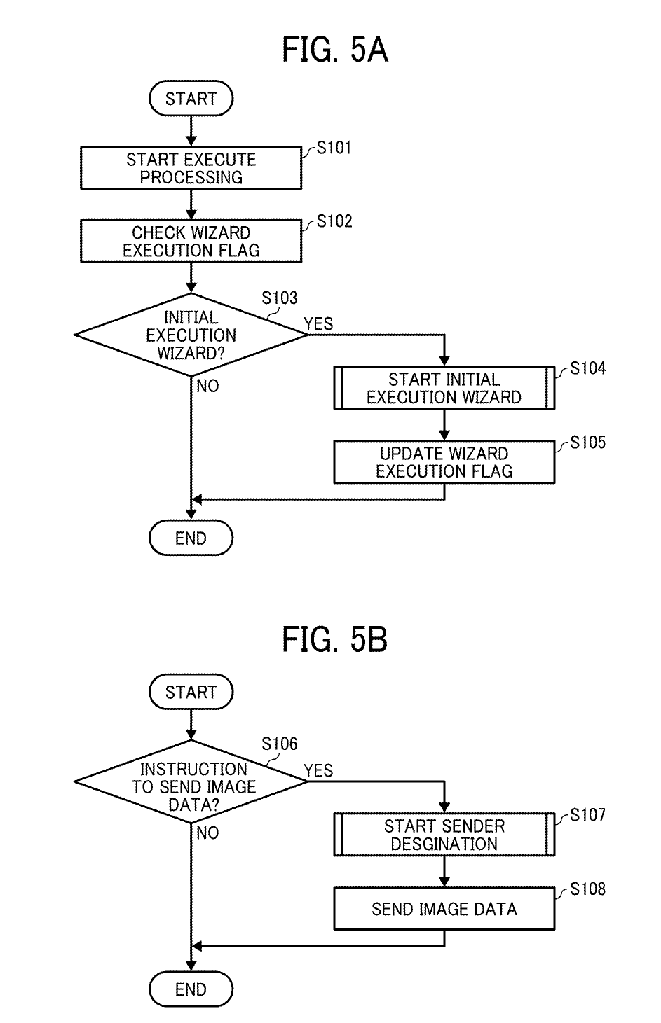

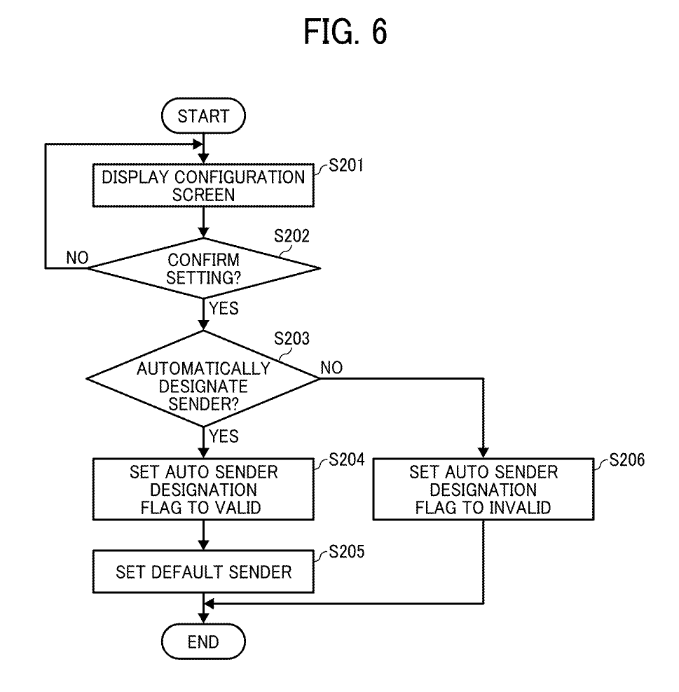

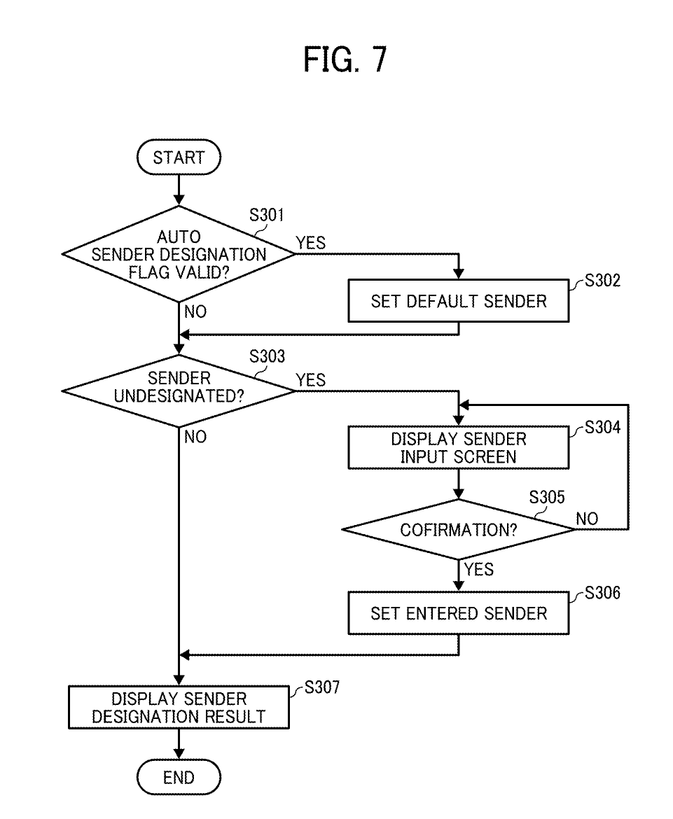

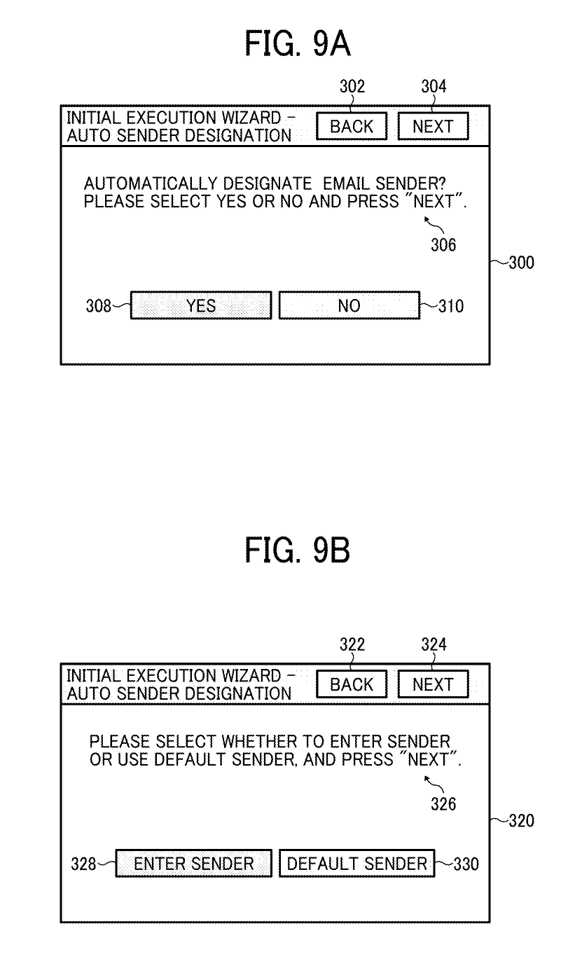

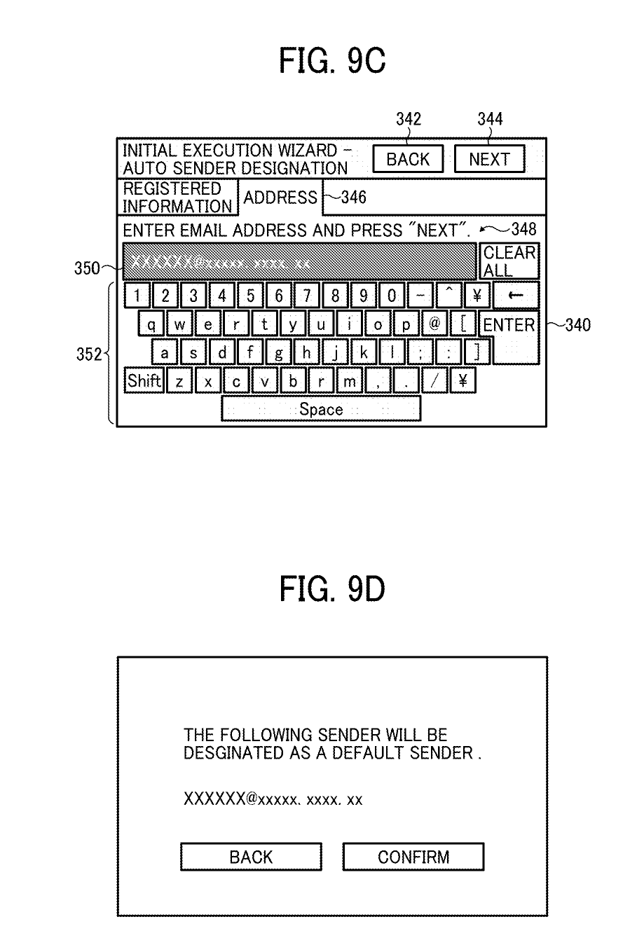

Referring now to FIGS. 5 to 7, and 9 to 10, operation of setting sender information through the initial execution wizard and transmitting image data using the sender information is explained according to an example embodiment of the present invention. FIG. 5A is a flowchart illustrating example execution processing performed by the MFP 20. FIG. 5B is a flowchart illustrating example operation of processing an instruction for executing scanned data email transmission. FIG. 6 is a flowchart illustrating example operation of setting automatic sender designation using an initial execution wizard, performed by the MFP 20. FIG. 7 is a flowchart illustrating example operation of setting sender information, performed by the MFP 20. FIGS. 9 and 10 illustrate example screens to be displayed on the display 32 of the MFP 20, in scanned data email transmission, in particular, in setting automatic sender designation.

The MFP 20 starts operation of FIG. 5A in response to turning on of the MFP 20. At S101, the CPU 22 of the MFP 20 reads an initial program loader (IPL) from the ROM 26, and a control program from the HDD 28, and causes the execution processor 202 to start execution processing, as described above referring to FIG. 4.

At S102, the CPU 22 of the MFP 20 calls the initial execution check processor 204 to refer to the wizard execution flag 220 stored in the ROM 26. At S103, the initial execution check processor 204 determines whether the wizard execution flag 220 has the value indicating that information regarding the automatic sender designation function is not set. When the wizard execution flag 220 has the invalid value indicating that information regarding the automatic sender designation function is not set, that is, the initial execution wizard is to be called (“YES” at S103), the operation proceeds to S104. At S104, the MFP 20 calls the wizard setting processor 206 to execute the initial execution wizard and perform operation of FIG. 6.

Referring to FIG. 6, at S201, the wizard setting processor 206 causes the display 32 to display a configuration screen 300 illustrated in FIG. 9A.

The configuration screen 300 of FIG. 9A is a screen, which requests the user to determine whether to allow the MFP 20 to automatically designate a sender of image data in scanned data email transmission. The configuration screen 300 includes the “Back” key 302, the “Next” key 304, and the message 306 that explains items to be set. When selected, the “Back” key 302 returns to a previous screen of the initial execution wizard. When selected, the “Next” key 304 proceeds to a next screen of the initial execution wizard to proceed to next processing with the currently-set item. The message 306 requests the user to select whether to automatically set a sender of image data for scanned data email transmission. The configuration screen 300 further includes the “YES” key 308 and the “NO” key 310. The “YES” key 308, when selected, accepts a user instruction to automatically set a sender of image data for scanned data email transmission. The “NO” key 310, when selected, accepts a user instruction not to automatically set a sender of image data for scanned data email transmission.

In this example illustrated in FIG. 9A, it is assumed that the “YES” key 308 is selected to automatically designate the sender. In such case, the wizard setting processor 206 switches from the configuration screen 300 of FIG. 9A to a confirmation screen 320 of FIG. 9D.

In response to the user input of the “Yes” key 308, the wizard setting processor 206 may display the confirmation screen 320 of FIG. 9D, which confirms the user to automatically designate a default sender in scanned data email transmission. The default sender may be an administrator of the MFP 20, which is previously set. The confirmation screen of FIG. 9D may display sender information, such as an email address of the default sender. In response to user selection of a “confirm” key in FIG. 9D, the wizard setting processor 206 accepts setting regarding automatic sender designation.

At S202 (FIG. 6), the wizard setting processor 206 determines whether the automatic sender designation setting is confirmed through the confirmation screen of FIG. 9D. When it is determined that no confirmation is received regarding setting of automatic sender designation (“NO” at S202), operation returns to S201. When it is determined that confirmation is received regarding setting of automatic sender designation (“YES” at S202), operation proceeds to S203. For example, when the user presses the “Next” key 324 on the configuration screen 320 after selection of the key 330, or when the user presses the “Next” key 344 on the configuration screen 340 after inputting the sender information, the display 32 may display a confirmation screen of FIG. 9D. When the user presses the “confirm” key that indicates confirmation of setting through the confirmation screen of FIG. 9D, it is determined that confirmation is received regarding setting.

At S203, the wizard setting processor 206 determines whether the user instruction that allows automatic sender designation is received. When it is determined that the user instruction that allows automatic sender designation is received (“YES” at S203), operation proceeds to S204. At S204, the wizard setting processor 206 sets the auto sender designation flag 222 to “valid”.

At S205, the wizard setting processor 206 updates the default sender data 224 such that a default sender is set to the sender that is entered by the user through the screen of FIG. 9C or selected by the user through the screen of FIG. 9B. For example, when the sender selects the “Default sender” 330, the wizard setting processor 206 sets an administrator of the MFP 20, and operation ends to proceed to S105 of FIG. 5. Alternatively, at S205, the wizard setting processor 206 may set a sender that is entered by the user using the initial execution wizard, as a default sender to be used in scanned data email transmission, when the “Enter sender” 328 is selected.

When it is determined that the user instruction that allows automatic sender designation is not received (“NO” at S203), that is, the user instruction that does not allow automatic sender designation is received, operation proceeds to S206. At S206, the wizard setting processor 206 sets the auto sender designation flag 222 to “invalid”, and operation ends to proceed to S105 of FIG. 5.

Referring back to FIG. 5, at S105, in response to completion of the initial execution wizard, the MFP 20 calls the initial setting recording processor 208 to update the value of the wizard execution flag 220 to “valid” that indicates that the initial execution wizard has been executed, and operation ends.

Operation of FIG. 5B is performed by the MFP 20, in response to an instruction received from the user through the operation panel. At S106, the instruction receiver 210 determines whether an instruction for executing scanned data email transmission is received from the user through the operation panel. When it is determined that the instruction for executing scanned data email transmission is received (“YES” at S106), operation proceeds to S107. At S107, the image sender 212, which receives the instruction for executing scanned data email transmission, calls the sender designation processor 214 to perform operation of FIG. 7.

Referring to FIG. 7, at S301, the sender designation processor 214 refers to the auto sender designation flag 222 stored in the ROM 23.

When the auto sender designation flag 222 is set to “valid” (“YES” at S301), operation proceeds to S302. At S302, the sender designation processor 214 obtains a default sender using the default sender data 224, and sets the default sender as a sender of image data to be transmitted. When it is determined that the auto sender designation flag 222 is set to “invalid” (“NO” at S301), operation proceeds to S303.

At S303, the sender designation processor 214 determines whether the sender is undesignated. In this example, when the sender has been designated by the user through the screen for scanned data email transmission (FIG. 10A), or when the auto sender designation flag 222 has been set to “valid” (“YES” at S301), it is determined that the sender has been designated to perform scanned data email transmission.

When it is determined that the sender is undesignated (“YES” at S303), operation proceeds to S304. At S304, the sender designation processor 214 displays a sender input screen as illustrated in FIG. 10B.

The sender input screen 360 of FIG. 10B includes a “Cancel” key 362, an “Enter” key 364, a tab 366 that allows selection of an item for display, and a message 368. When selected, the “Cancel” key 362 causes cancellation of entering of a sender, and returns to the previous screen such as a screen for scanned data email transmission (FIG. 10A). When selected, the “Enter” key 364 accepts the currently-set items. In this example illustrated in FIG. 10B, the “address” tab 366 is selected as an item for display, and the message 368 requests the user to enter an email address of the sender of image data. In such case, the sender input screen 360 further includes a software keyboard 372, which allows the user to directly enter the email address of the sender, and a text box 370 that displays the sender input by the user.

The user who selects the “address” tab 366 as the item to be set, enters a desired email address of the sender using the software keyboard 372, and presses the “Enter” key 364, to directly enter the sender information to be registered. The sender information to be registered may be other than an email address of the sender, such as a name of the sender, if a destination address may be obtained using the name of the sender.

At S305, the sender designation processor 214 determines whether an instruction for confirming the sender is received through the sender input screen 360 of FIG. 10B. When it is determined that the instruction for confirming is not received (“NO” at S305), operation returns to S304. When it is determined that the instruction for confirming is received (“YES” at S305), operation proceeds to S306. At S306, the sender designation processor 214 designates the user, which is entered through the sender input screen 360, and operation proceeds to S307.

When it is determined that the sender is designated (“NO” at S303), operation proceeds to S307. At S307, the sender designation processor 214 causes the display 32 to display a sender designation result screen as illustrated in FIG. 10C.

The sender designation result screen 380 of FIG. 10C is similar to the screen for scanned data email transmission of FIG. 10A. More specifically, the sender designation result screen 380 includes a part 382 having a text box and geographical user interface (GUI) components (“TO” “CC” AND “BCC”) that indicate or allow the user to enter a destination address, a text box 384 that displays the designated sender, an “Auto designation” key 386, an “Enter sender” key 388, a part 390 having a text box and GUI components (“FORMAT” and “ENTER”) that indicate or allow the user to enter the subject of email, and GUI components 392 to 398 that indicate various settings regarding image data to be transmitted or email transmission. The “Auto designation” key 386, when selected, indicates that the sender is automatically designated. The “Enter sender” key 388, when selected, indicates that the sender is entered by the user.

In this example illustrated in FIG. 10C, it is assumed that the auto sender designation flag is set to invalid at S301, and the sender is entered by the user at S304. The text box 384 displays thereon the email address directly input by the user. When the “Confirm” key is pressed, the MFP 20 accepts an instruction for sending the scanned data via email, with information regarding the sender that is displayed on the screen of FIG. 10C, and operation ends to proceed to S108 of FIG. 5B. At the same time, the sender entered through the sender input screen is registered in the internal memory of the MFP 20 as a user that can be selected as a sender in scanned data email transmission.

Referring back to FIG. 5, at S108, the MFP 20 sends the image data to the specific destination address, with an attachment of the image data that is scanned, and operation ends. More specifically, email data includes the sender information that is either automatically designated or directly entered by the user.

As described above referring to FIG. 5A, the MFP 20 is programmed to automatically executes the initial execution wizard after turning on of the MFP 20, when the wizard execution flag 220 indicates that setting is not completed. Since the initial execution wizard is automatically called, the user is able to know that setting is needed before using a function of the MFP 20, such as the scanned data email transmission. This suppresses the user from not setting information that is needed for performing the function of the MFP 20, such as the scanned data email transmission.

Further, even when setting regarding the scanned data email transmission is not set, the MFP 20 is programmed to check whether information needed for performing scanned data email transmission has been set, in response to a user instruction for executing the scanned data email transmission. For example, the MFP 20 checks whether the sender information needed for scanned data email transmission has been set. When the sender information has not been set, the MFP 20 switches, from a screen for scanned data email transmission, to a sender input screen that requests the user to enter the sender information. Accordingly, the user can input sender information without cancelling the user instruction to carry out the scanned data email transmission operation.

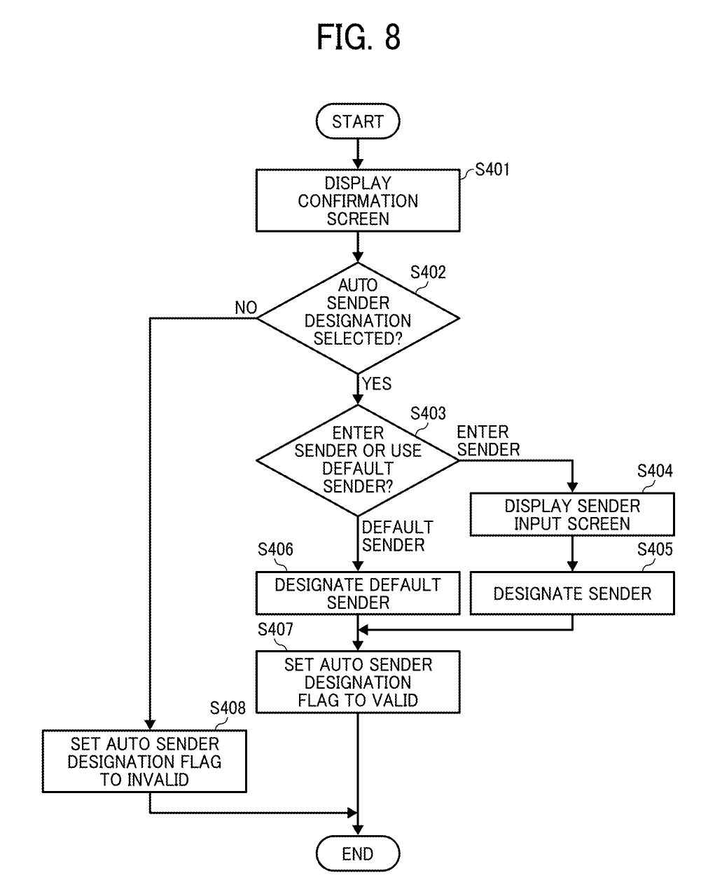

The above-described operation of setting a sender of image data may be performed in various other ways. For example, operation of performing execution processing using the initial execution wizard may be performed differently than the above-described operation of FIG. 6, as described below referring to FIG. 8. More specifically, at S104 of FIG. 5, the MFP 20 calls the wizard setting processor 206 to execute the initial execution wizard and perform operation of FIG. 8.

At S401, the wizard setting processor 206 causes the display 32 to display the configuration screen 300 of FIG. 9A. When the “Next” key 304 is pressed, the configuration screen 300 is switched to the configuration screen 320 of FIG. 9B. Assuming that the user selects the key 308 or 310 through the configuration screen 300 and presses the “Next” key 304, operation proceeds to S402.

At S402, the wizard setting processor 206 determines whether auto sender designation is selected through the configuration screen 300. For example, the wizard setting processor 206 determines whether the “YES” key 308 or “NO” key 310 is selected based on the user input received through the configuration screen 300. When it is determined that the auto sender designation is selected (“YES” at S402), operation proceeds to S403. Otherwise (“NO” at S402), operation proceeds to S408 to set the auto sender designation flag 222 to “invalid”.

Assuming that the “YES” key 308 is selected on the screen 300 of FIG. 9A, the wizard setting processor 206 switches to a configuration screen 320 of FIG. 9B. The configuration screen 320 of FIG. 9B includes a “Back” key 322 that returns to the previous screen, a “Next” key 324 that proceeds to a next screen, and a message 326 indicating an item to be set. In this example, the message 326 requests the user to enter a sender to be used as an automatically designated user, or to use a default user that is previously set as an automatically designated user. For example, the default user may be previously set by a vendor. In this example, the “administrator” of the MFP 20 is previously set as a default sender. The configuration screen 320 further includes an “Enter sender” key 328 that accepts a user input regarding the user, and a “Default sender” key 330 that accepts to use a default sender. In alternative to displaying the “Default sender”, the “Administrator” may be displayed to clearly indicate that who the default user is.

At S403, the wizard setting processor 206 further determines whether the sender is to be directly entered by the user, or the default sender is to be used. For example, the wizard setting processor 206 determines whether the “Enter sender” key 328 or the “Default sender” key 330 is selected through the configuration screen 320. When it is determined that the sender is to be entered (“Enter sender” at S403), operation proceeds to S404.

At S404, the wizard setting processor 206 of the MFP 20 causes the display 32 to display a configuration screen 340 of FIG. 9C.

The configuration screen 340 of FIG. 9C includes a “Back” key 342 that returns to the previous screen, a “Next” key 344 that proceeds to a next screen, a tab 346 that allows the user to select an item for display, and a message 348 indicating an item to be set. In this example illustrated in FIG. 9C, the “address” tab 346 is selected as an item for display, and the message 348 requests the user to enter an email address of the sender of image data. In such case, the configuration screen 340 further includes a software keyboard 352 that allows the user to directly input sender information such as an email address of the sender, and a text box 350 that displays the entered email address of the sender.

The user who selects the “address” tab 346 as the item to be set, enters a desired email address of the sender using the software keyboard 352, and presses the “Enter” key 344, to directly enter the sender information to be registered. The sender information to be registered may be other than an email address of the sender, such as a name of the sender, for example, if a destination address can be specified using such sender information.

In this example, in response to the user input of the sender email address, the wizard setting processor 206 may further display the confirmation screen of FIG. 9D, which confirms the user to register the entered user as a default user in scanned data email transmission.

At S405, the wizard setting processor 206 sets the sender entered through the configuration screen 340 as a default sender, rewrites the default sender data 224 with the entered sender, and operation proceeds to S407.

When the wizard setting processor 206 determines that the default sender is to be used (“DEFAULT SENDER” at S403), operation proceeds to S406. At S406, the wizard setting processor 206 sets the default sender that is previously set (in this example, the administrator of the MFP 20), and rewrites the default sender data 224 with the default sender, and operation proceeds to S407.

At S407, the wizard setting processor 206 sets the auto sender designation flag 222 to “valid”, and operation ends to return to operation of FIG. 5.

When it is determined that auto sender designation is not selected (“NO” at S402), that is “NO” key 310 is selected, operation proceeds to S408. At S408, the wizard setting processor 206 sets the auto sender designation flag 222 to “invalid”, and operation ends to return to operation of FIG. 5A.

In the above-described operation of FIG. 8, the MFP 20 allows the user to enter a sender of image data, which may be set default. Further, the MFP 20 allows the user to use a default sender that is previously set, such as an administrator of the MFP 20. With this configuration, the user can easily set a sender of image data for scanned data email transmission.

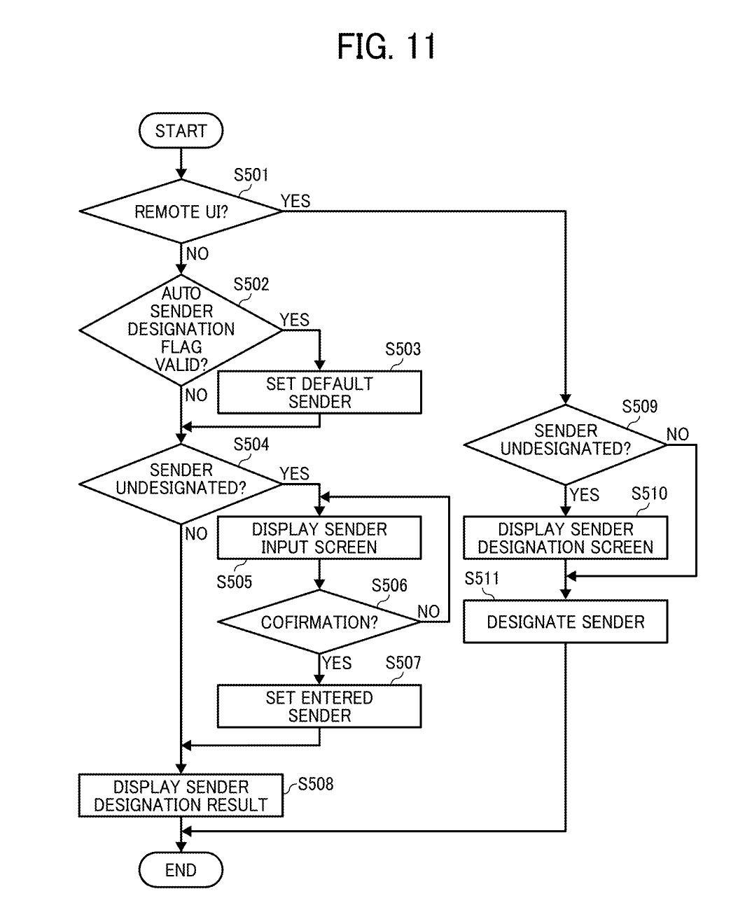

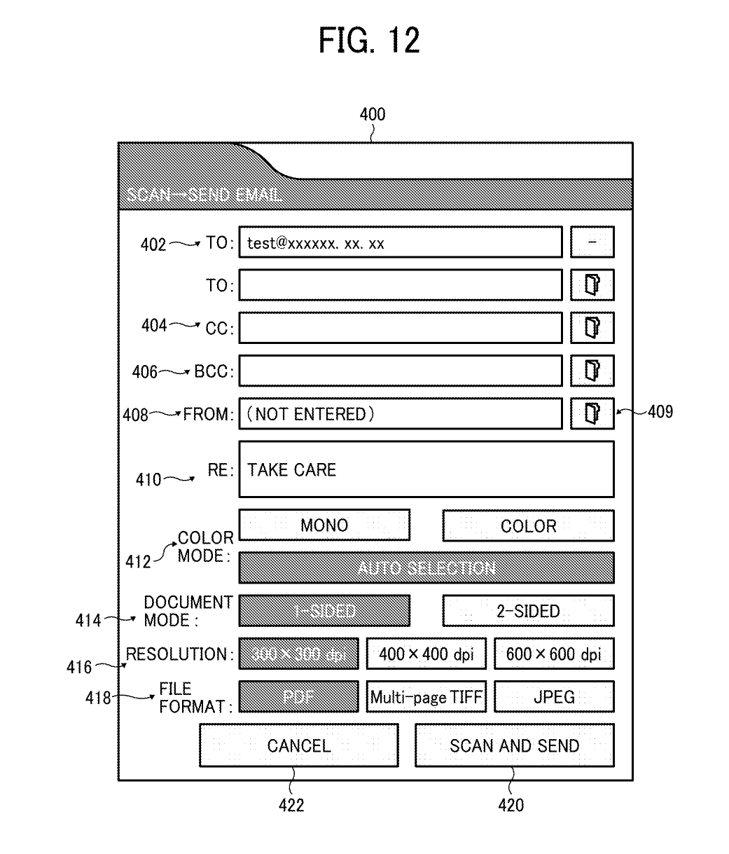

Referring now to FIGS. 11 and 12, operation of sending image data via email and setting a sender of image data is explained according to an example embodiment of the present invention. In this example, the MFP 20 determines whether a user instruction for executing scanned data email transmission is received directly from the operation panel of the MFP 20, or remotely from the client 14 through the network 12. Based on determination, the MFP 20 operates differently.

FIG. 11 is a flowchart illustrating operation of designating a sender, performed by the MFP 20, according to an example embodiment of the present invention. The operation of FIG. 11 may be performed at S107 of FIG. 5B in response to an instruction for executing scanned data email transmission at S106. FIG. 12 is an example screen for designating a sender, which is to be displayed onto a display of the client 14.

At S107 of FIG. 5B, the MFP 20 calls the sender designation processor 214 to perform operation of FIG. 11.

Referring to FIG. 11, at S501, the sender designation processor 214 determines whether the user instruction for executing scanned data email transmission is received through the operation panel, or through a remote user interface such as from the client 14. When it is determined that the user instruction is received through the operation panel (“NO” at S501), operation proceeds to S502. S502 to S508 are performed in a substantially similar manner as described above referring to S301 to S307 of FIG. 7, such that explanation thereof is omitted.

At S501, when it is determined that the user instruction is received from the remote UI (“YES” at S501), operation proceeds to S509.

At S509, the sender designation processor 214 determines whether the sender is undesignated. In this example, when the sender has been designated by the user through the screen for scanned data email transmission (FIG. 10A), or when the auto sender designation flag 222 has been set to “valid”, it is determined that the sender has been designated to perform scanned data email transmission.

When it is determined that the user is undesignated (“YES” at S509), operation proceeds to S510. At S510, the sender designation processor 214 causes the display 32 to display a sender designation screen as illustrated in FIG. 12, onto a remote UI screen, such as the display, of the client 14.

The sender designation screen 400 of FIG. 12 includes various items to be used for instructing scanned data email transmission. More specifically, the sender designation screen 400 includes GUI components 402 to 406 that indicate a destination of email data, GUI components 408 and 409 that indicate designation of a sender, a GUI component 410 that indicates the subject, GUI components 412 to 418 that indicate various settings regarding image data to be transmitted or email transmission, a “Cancel” key 422 for cancelling scanned data email transmission, and a “Scan and send” key 420 to execute scanned data email transmission.

In this example, the GUI component 408 indicates that the sender is not entered. In one example, the user may select the GUI 409 to select a sender from previously entered senders. For example, when the GUI 409 is tapped or clicked, the client 14 may display a screen that allows the user to select an email address from the user's address book. Alternatively, the user may directly enter sender information such as an email address of the sender, onto the GUI 408, using a keyboard provided for the client 14. The user further taps or clicks the key 420 to execute the scanned data email transmission.

At S511, the sender designation processor 214 receives a sender entered through the sender designation screen 400 from the client 14, designates the entered sender, and operation ends to return to operation of FIG. 5B to perform S108.

When it is determined that the sender is designated (“NO” at S509), operation proceeds to S511. At S511, the sender designation processor 214 designates the designated sender, and operation ends to return to operation of FIG. 5.

As described above referring to FIGS. 4 to 10, the MFP 20 is provided with the auto sender designation function, so that the user does not have to input sender information using the operation panel of the MFP 20 in scanned data email transmission. However, if the user operates the MFP 20 to perform scanned data email transmission through a remote UI, such as the client 14, the user can easily enter sender information using an input device of the client 14. In view of this, referring to FIGS. 11 and 12, the MFP 20 determines to automatically designate the sender only when an instruction is received from the user through the operation panel. When it is determined that an instruction is received from the user through the client 14, such as a smart phone or a tablet, the MFP 20 does not automatically designate the sender, based on assumption that the user is more comfortable with inputting sender information through the client 14.

In the above-described operation, the MFP 20 is explained as an example of an image processing apparatus capable of setting information to be used for data transmission. The other examples of image processing apparatus include, but not limited to, an image reading apparatus such as a network scanner, an image transmission apparatus such as a facsimile, and an image capturing apparatus such as a still camera or a video camera with network communication capability. Since data to be transmitted does not have to be scanned at the image processing apparatus, such apparatus capable of setting information to be used may be referred to as an information processing apparatus. Further, data may be transmitted in any desired method, for example, using the Internet facsimile according to ITU-T.37.

Further, any one of the above-described functional modules including the initial execution wizard may be implemented by a computer executable program described in legacy programming language such as assembler, C, C++, C#, Java, or object-oriented programming language. Such program may be stored in any desired recording medium such as ROM, EEPROM, EPROM, flash memory, flexible disk, CD-ROM, CD-RW, DVD-ROM, DVD-RAM, DVD-RW, blue-ray disc, SD card, and MO. Further, such program may be distributed over a network.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Further, any of the above-described devices or units can be implemented as a hardware apparatus, such as a special-purpose circuit or device, or as a hardware/software combination, such as a processor executing a software program.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In one example, the present invention may reside in an image processing apparatus capable of transmitting data through a network. The image processing apparatus includes a memory that stores setting information indicating whether automatic sender designation information is configured. For example, the setting information is a wizard execution flag 220. Further, the automatic sender designation information indicates whether to automatically designate a sender of data to be transmitted, such as the automatic sender designation flag 222. The image processing apparatus further includes a processor to be executed in response to turning on of the image processing apparatus. The processor determines whether the automatic sender designation information is configured based on the setting information, and displays on a display a first interactive screen that guides a user to configure the automatic sender designation information when the setting information indicates that the automatic sender designation information is not configured. For example, the first interactive screen is a screen, which is generated using an initial execution wizard. The image processing apparatus further updates the setting information in the memory to indicate that the automatic sender designation information is configured in response to configuration of the automatic sender designation information by the user through the first interactive screen so as to prevent display of the first interactive screen when the image processing apparatus is tuned on for the next time. The image processing apparatus determines whether to automatically designate a sender of data to be transmitted when an instruction for transmitting data is received, based on the automatic sender designation information that is configured.

Further, in one example, in response to a user instruction for transmitting data to a destination, the processor refers to the automatic sender designation information that is configured. The processor automatically designates a sender of data to be transmitted according to the sender information stored in the memory, in preparation for transmitting data to the destination, when the automatic sender designation information indicates to automatically designate a sender of data to be transmitted. The processor displays on the display a second interactive screen that requests the user to designate a sender of data to be transmitted, when the automatic sender designation information indicates not to automatically designate a sender of data to be transmitted.

Further, in one example, the first interactive screen or the second interactive screen further requests the user to select whether to designate a default user previously set or to designate a sender to be entered by the user, as a sender of data to be transmitted.

1. An image processing apparatus, comprising:
a network interface that transmits data through a network;
a memory that stores setting information indicating whether automatic sender designation information is configured, the automatic sender designation information indicating whether to automatically designate a sender of data to be transmitted; and
a processor to be executed in response to turning on of the image processing apparatus, the processor being configured to,
determine whether the automatic sender designation information is configured based on the setting information,
display on a display a first interactive screen that guides a user to configure the automatic sender designation information when the setting information indicates that the automatic sender designation information is not configured,
updates the setting information in the memory to indicate that the automatic sender designation information is configured in response to configuration of the automatic sender designation information by the user through the first interactive screen so as to prevent display of the first interactive screen when the image processing apparatus is tuned on for the next time, and
determines whether to automatically designate a sender of data to be transmitted when an instruction for transmitting data is received, based on the automatic sender designation information that is configured.

2. The image processing apparatus of claim 1, wherein
the memory further stores the automatic sender designation information indicating whether to automatically designate a sender of data to be transmitted, and
the processor further updates the automatic sender designation information in the memory, with the automatic sender designation information that is configured.

3. The image processing apparatus of claim 2, wherein
the memory further stores sender information indicating a sender to be automatically designated as a sender of data to be transmitted.

4. The image processing apparatus of claim 3, wherein, in response to the user instruction for transmitting data to a destination,
the processor automatically designates a sender of data to be transmitted according to the sender information stored in the memory, in preparation for transmitting data to the destination, when the automatic sender designation information indicates to automatically designate a sender of data to be transmitted, and
the processor displays on the display a second interactive screen that requests the user to designate a sender of data to be transmitted, when the automatic sender designation information indicates not to automatically designate a sender of data to be transmitted.

5. The image processing apparatus of claim 4, wherein the second interactive screen further requests the user to select whether to designate a default user previously set or to designate a sender to be entered by the user, as a sender of data to be transmitted.

6. The image processing apparatus of claim 4, wherein, in response to the user instruction for transmitting data,
the processor further determines whether the user instruction is received through the network interface, and displays the second interactive screen only when the user instruction is not received through the network interface.

7. The image processing apparatus of claim 3, wherein
the first interactive screen further requests the user to select whether to designate a default user previously set or to designate a sender to be entered by the user, as a sender of data to be transmitted, and
when the user enters sender information after selection of the sender to be entered by the user, the processor updates the sender information stored in the memory, with the sender information entered by the user.

8. The image processing apparatus of claim 3, wherein the processor generates email data including the sender information of the sender that is automatically designated, and transmits the email data to a destination through the network.

9. The image processing apparatus of claim 1, wherein the processor executes an initial execution wizard when the setting information indicates that the automatic sender designation information is not configured, and causes the initial execution wizard to generate the first interactive screen for display.

10. A method of configuring setting information to be used in transmitting data through a network by an image processing apparatus, the method comprising:
storing in a memory setting information indicating whether automatic sender designation information is configured, the automatic sender designation information indicating whether to automatically designate a sender of data to be transmitted;
using a processor, determining whether the automatic sender designation information is configured based on the setting information, in response to turning on of the image processing apparatus;
displaying on a display a first interactive screen that guides a user to configure the automatic sender designation information when the setting information indicates that the automatic sender designation information is not configured,
updating the setting information in the memory to indicate that the automatic sender designation information is configured in response to configuration of the automatic sender designation information by the user through the first interactive screen so as to prevent display of the first interactive screen when the image processing apparatus is tuned on for the next time, and
determining whether to automatically designate a sender of data to be transmitted when an instruction for transmitting data is received, based on the automatic sender designation information that is configured.

11. The method of claim 10, further comprising:
storing in the memory the automatic sender designation information indicating whether to automatically designate a sender of data to be transmitted;
updating the automatic sender designation information in the memory, with the automatic sender designation information that is configured; and
storing in the memory sender information indicating a sender to be automatically designated as a sender of data to be transmitted.

12. The method of claim 11, wherein, in response to the user instruction for transmitting data to a destination, the method further comprising:
automatically designating a sender of data to be transmitted according to the sender information stored in the memory, in preparation for transmitting data to the destination, when the automatic sender designation information indicates to automatically designate a sender of data to be transmitted, and
displaying on the display a second interactive screen that requests the user to designate a sender of data to be transmitted, when the automatic sender designation information indicates not to automatically designate a sender of data to be transmitted.

13. The method of claim 12, wherein the displaying on the display a second interactive screen includes:
requesting the user to select whether to designate a default user previously set or to designate a sender to be entered by the user, as a sender of data to be transmitted.

14. The method of claim 12, wherein, in response to the user instruction for transmitting data, the method further comprising:
determining whether the user instruction is received through the network interface; and
displaying the second interactive screen only when the user instruction is not received through the network interface.

15. The method of claim 11, further comprising:
using the first interactive screen, requesting the user to select whether to designate a default user previously set or to designate a sender to be entered by the user, as a sender of data to be transmitted, and
when the user enters sender information after selection of the sender to be entered by the user, updating the sender information stored in the memory, with the sender information entered by the user.

16. The method of claim 11, further comprising:
generating email data including the sender information of the sender that is automatically designated; and
transmitting the email data to a destination through the network.

17. The method of claim 10, further comprising:
executing an initial execution wizard when the setting information indicates that the automatic sender designation information is not configured; and
using the initial execution wizard, generating the first interactive screen for display.

18. A non-transitory recording medium, when executed by one or more processors, cause the processors to perform a method of configuring setting information to be used in transmitting data through a network by an image processing apparatus, the method comprising:
storing in a memory setting information indicating whether automatic sender designation information is configured, the automatic sender designation information indicating whether to automatically designate a sender of data to be transmitted;
determining whether the automatic sender designation information is configured based on the setting information, in response to turning on of the image processing apparatus;
displaying on a display a first interactive screen that guides a user to configure the automatic sender designation information when the setting information indicates that the automatic sender designation information is not configured,
updating the setting information in the memory to indicate that the automatic sender designation information is configured in response to configuration of the automatic sender designation information by the user through the first interactive screen so as to prevent display of the first interactive screen when the image processing apparatus is tuned on for the next time, and
determining whether to automatically designate a sender of data to be transmitted when an instruction for transmitting data is received, based on the automatic sender designation information that is configured.
